(19) United States
(12) Patent Application Publication
(10) Pub. No.: US 2026/0116089 A1
(43) Pub. Date: Apr. 30, 2026

(54) Selective Application of Graphical Indicators for Radiofrequency Encoding Operations

(71) Applicant: ZEBRA TECHNOLOGIES CORPORATION, Lincolnshire, IL (US)

(72) Inventors: Blake E. Nemura, Saint Charles, IL (US); Chris H. Robertson, Oark, AR (US)

(73) Assignee: ZEBRA TECHNOLOGIES CORPORATION, Lincolnshire, IL (US)

(21) Appl. No.: 18/924,823

(22) Filed: Oct. 23, 2024

Related U.S. Application Data
(60) Provisional application No. 63/700,448, filed on Sep. 27, 2024.

(51) Int. Cl. B41J 3/46; B41J 3/407; B41J 3/50

(52) U.S. Cl. CPC B41J 3/46; B41J 3/4075; B41J 3/50

(57) ABSTRACT

A method in a media processing device includes: receiving a command including first data and second data; based on the second data, performing an encoding operation on a radiofrequency (RF) tag associated with a label; selecting an indicator based on an outcome of the encoding operation; and controlling a printhead to apply the first data and the indicator to the label.

### CROSS-REFERENCE TO RELATED APPLICATIONS

This application claims priority from U.S. provisional patent application no. 63/700448 filed on Sep. 27, 2024, the contents of which is incorporated herein by reference.

### BACKGROUND

Labels and other media can include embedded radiofrequency (RF) tags, e.g., to store identifiers of items the labels are affixed to. The labels can also bear graphical indicia, such as barcodes, text, or the like. If an operation to write data to an RF tag embedded in a label fails, the label may be voided, e.g., with the graphical indicia being omitted or the like.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a media processing device.

FIG. 2 is a cross section of the media processing device of FIG. 1.

FIG. 3 is a flowchart of a method for selective application of graphical indicators for RF encoding operations.

FIG. 4 is a diagram illustrating an example performance of the method of FIG. 3.

FIG. 5 is a diagram illustrating another example performance of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Examples disclosed herein are directed to a method in a media processing device. The method includes: receiving a command including first data and second data; based on the second data, performing an operation on a radiofrequency (RF) tag associated with a label; selecting an indicator based on an outcome of the operation; and controlling a printhead to apply the first data and the indicator to the label.

Additional examples disclosed herein are directed to a device, comprising: a housing; a printhead disposed in the housing, the printhead being configured to print on a media supply; a radiofrequency (RF) assembly disposed in the housing; and a controller configured to: receive a command including first data and second data; based on the second data, controlling the RF assembly to perform an operation on a RF tag associated with a label of the media supply; select an indicator based on an outcome of the operation; and control the printhead to apply the first data and the indicator to the label.

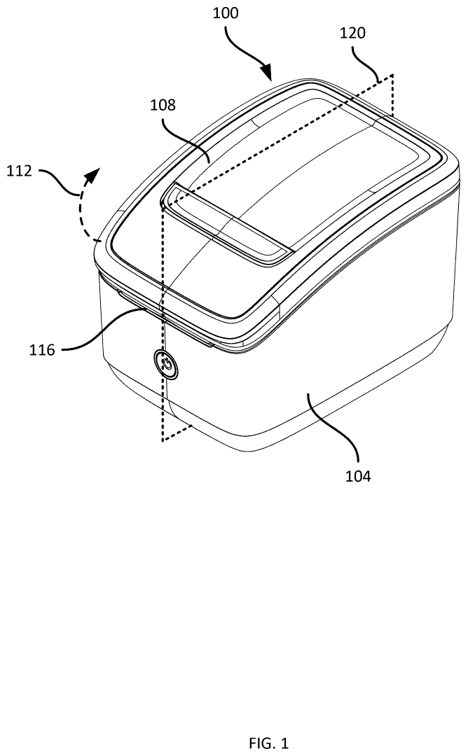

FIG. 1 illustrates an example device in the form of a media processing device 100, such as a label printer (also referred to herein as the printer 100). The printer 100 can be implemented as a desktop printer, as illustrated. The printer 100 can also be implemented in a wide variety of other form factors, including a mobile printer, tabletop or industrial printer, or the like. The printer 100 includes various components configured to apply indicia to media such as discrete labels, a continuous paper strip, identity cards, or the like. The indicia can be applied, for example, by direct thermal printing, thermal transfer printing, or the like. In other examples, the media processing device 100 can include a radio frequency (RF) transcoder (e.g., encoder/reader) assembly configured to read data from RF tags embedded in the labels, write data to RF tags embedded in labels or other media, in addition to or instead of applying indicia to the media.

The printer 100 includes a body 104 housing a media supply, a printhead, and other components, as well as a cover or door 108 configured to open (e.g., in a direction 112) to provide access to an interior of the printer 100. The printer 100 further includes an outlet 116, from which processed media (e.g., labels with indicia having been applied thereto within the body 104 of the printer 100) is dispensed.

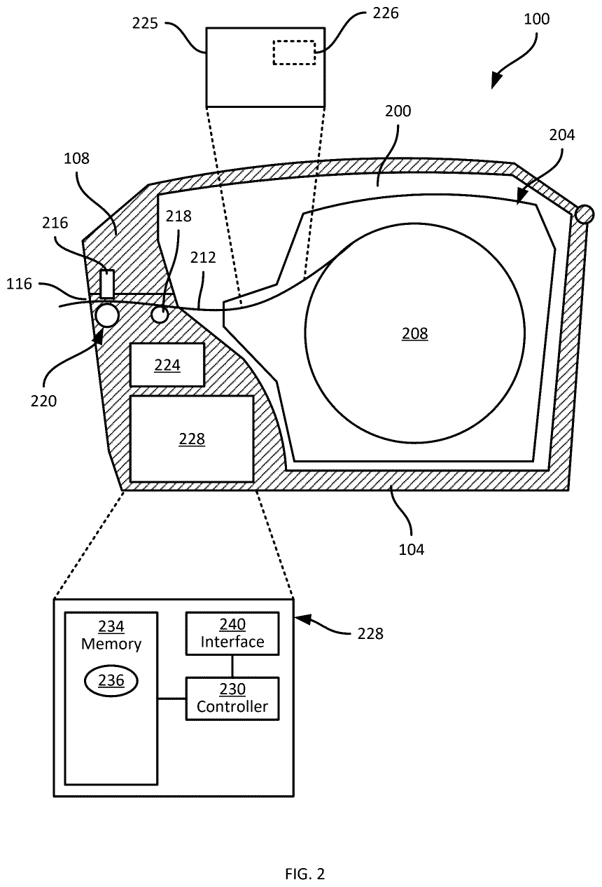

FIG. 2 illustrates a simplified cross sectional view of the printer 100, taken at the plane 120 shown in FIG. 1. As seen in FIG. 2, the body 104 and the cover 108 define a chamber 200 for receiving one or more media supplies, such as a roll 208 of paper, labels, or the like, a media cartridge 204 (also referred to herein as a supply 204) containing a roll 208 of paper, labels, or the like, or other media supplies. In other examples, the media supplies accommodated in the chamber 200 can include boxes of fan-feed labels, identity cards, or the like. In still other examples, the printer 100 can include an inlet in the body 104 for receiving media from an external supply, e.g., to travel through the chamber 200 for processing.

Media 212 from the supply 204 (e.g., from the roll 208, in the illustrated example) travels along a media path from the supply 204 to a nip formed by a printhead 216 and a platen roller 220. The media path can be defined by surfaces, rollers, and the like, such as a guide roller 218 (e.g., a passive, or non-driven, roller). The platen roller 220 can be driven, e.g., to pull the media 212 along the media path and through the nip, where the printhead 216 applies indicia to the media 212. The processed media (e.g., bearing indicia applied by the printhead 216) is then dispensed at the outlet 116. The device 100 also includes an RF transcoder 224 (which may also be referred to as an RF assembly 224), e.g., including one or more antennas and associated controllers, configured to read data from and/or write data to RF tags embedded in the media. For example, the supply 204 can be a roll of labels, an example label 225 of which is shown in FIG. 2 in overhead view, with an embedded RF tag 226.

The device 100 further includes a control subsystem 228. As shown in FIG. 2, the control subsystem 228 can include a controller 230 such as a central processing unit (CPU), an application-specific integrated circuit (ASIC), or the like, connected to and/or integrated with a memory 234 storing a plurality of computer-executable instructions. The instructions can include, for example, a control application 236, e.g., implemented as firmware or the like.

The subsystem 228 can also include a communication interface 240, e.g., including one or more antennas and/or data ports and associated control hardware permitting the device 100 to communicate with other computing devices. For example, the device 100 can receive media processing commands from a host computing device (e.g., a desktop computer, a smartphone, server, or the like), including data such as text, images, or the like, to be printed onto media from the supply 204 (e.g., onto a given label). The device 100 can also receive data to be written to an RF tag embedded in the media. For example, the command can include an electronic product identifier (EPC) to be written to the RF tag 226 of a given label 225.

To execute a media processing command, the controller 230 can control the printhead 216 to apply indicia to the media 212, e.g., by activating thermal elements of the printhead 216 to apply heat to corresponding portions of the media 212. As will be apparent to those skilled in the art, for direct thermal printers, as shown in FIG. 2, application of heat to a portion of the media 212 may activate a thermochromic pigment in the media 212. For thermal transfer printers, a pigment-carrying ribbon (not shown) can traverse the nip with the media 212, and application of heat to a portion of the media 212 and the ribbon can cause the transfer of pigment from the ribbon to the media 212.

The controller 230 can further control the RF transcoder 224 to perform one or more operations, which may also be referred to as encoding operations. The operations can be specified in the media processing command. The encoding operations can include reading data from the RF tag 226, such as data stored in a tag identifier (TID) memory bank of the RF tag 226. The TID data can include a model number of the RF tag 226 (e.g., which may be the same for each tag 226 in the roll 208), a serial number corresponding to the tag RF 226, or the like. The encoding operations can also include writing data included in the command to a memory of the RF tag 226, such as an electronic product code (EPC) or other item identifier, which can be written to an EPC memory bank of the RF tag 226. The encoding operations can also include writing data included in the command to an auxiliary memory bank of the RF tag, distinct from the EPC bank. In other words, the device 100 can perform one or more encoding operations on the RF tag 226 of a given label 225, including either or both of read and write operations. Some encoding operations can be specified in the command, and the device 100 can be configured to perform other encoding operations independently of the contents of the command. For example, the device 100 can be configured to read the TID bank of the tag 226 without that read operation being specified in the command, e.g., to verify that the tag 226 is functional.

Under some conditions, one or more of the encoding operations may fail for a given RF tag 226. For example, a physically damaged tag may not be readable and/or writable. In other examples, the command may include data incompatible with the RF tag 226, e.g., a volume of data greater than a storage capacity of the RF tag 226.

In some media processing devices, failure of an RF encoding operation can lead to voiding the relevant label 225, e.g., printing the word “VOID” or another error indicator over some or all of a printable surface of the label 225. The error indicator may be printed instead of the print data included in the command (e.g., text, barcodes, images, or the like), or in addition to the print data, e.g., overlaying the print data or interlaced with the print data. In other words, if an RF encoding operation fails, the label 225 may be rendered substantially unusable for both RF-based data retrieval from the label 225, and graphical data retrieval from the label 225, e.g., via image-based scanners.

In some use cases, such as labels used in transport and logistics operations, e.g., last-mile deliveries, a label 225 with a failed RF tag 226 may not be a significant impediment to use. That is, the graphical indicia printed on the label 225 may be sufficient to enable the transport and logistics operations to proceed. In those use cases, voiding a label due to a failed RF encoding operation may therefore be wasteful. However, disabling or otherwise ceasing the voiding of labels that experienced failed RF encoding operations may also be wasteful, e.g., due to later attempts to perform RF read operations on those labels.

The device 100 is configured to mitigate or avoid the loss of labels and/or the performance of unnecessary attempts to read an RF tag 226 by selectively printing RF encoding indicators on the label 225, dependent on the outcome (e.g., success or failure) of the RF operations. The indicators can be non-overlapping with other print data, such that any graphical indicia contained in the print data remain usable when the label 225 is printed.

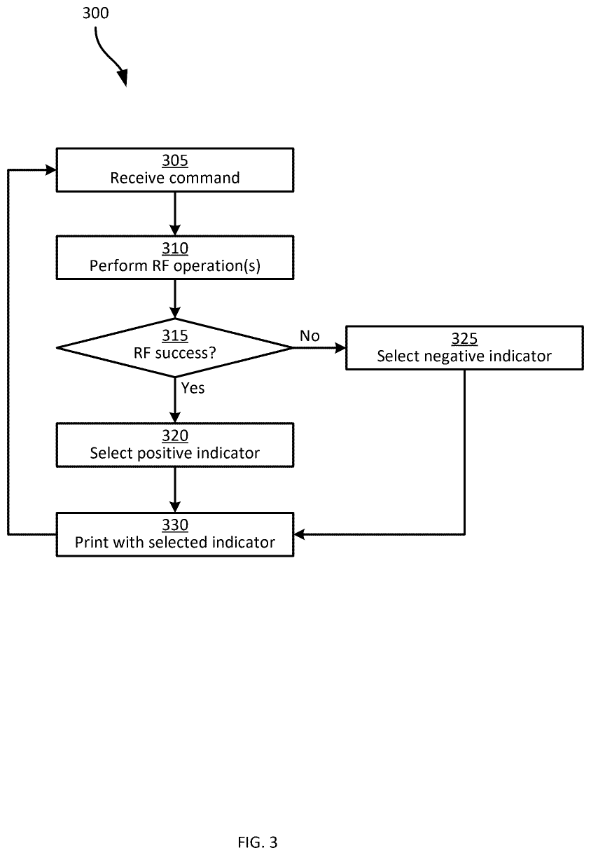

Turning to FIG. 3, a method 300 of selectively applying graphical indicators corresponding to RF encoding operation outcomes is illustrated. The method 300 will be described in conjunction with its performance in the device 100, and in particular by the controller 230, via execution of the application 236.

At block 305, the device 100 is configured to receive a command, e.g., from another computing device in communication with the device 100. The command can be referred to as a media processing command or a print command, and includes data to be printed on the label 225 (also referred to as print data for brevity), and data to be written to the RF tag 226 and/or read from the RF tag 226 (also referred to as RF data for brevity). The nature of the print data and the RF data can vary depending on the environment in which the device 100 operates. For example, when the device 100 is used to print shipping labels, the print data can include text including a destination mailing address and a suitable identifier encoded with any of a variety of barcode symbologies (e.g., maxicode, code128, code39, DataMatrix, universal product code (UPC), or the like). The print data can also include a barcode encoding the UPC or other identifier, or an instruction to the device 100 to generate such a barcode for printing on the label 225. The RF data can include a string defining an electronic product code or other suitable identifier, for example. In some implementations, the RF data and the print data can include the same item identifier (e.g., a UPC).

At block 310, the device 100 is configured to perform one or more RF encoding operations, based on the RF data in the command. The RF encoding operations can include, for example writing the RF data from the command to the RF tag 226, e.g., to an EPC bank of the RF tag 226. The performance of RF encoding operation(s) can precede the application of graphical indicia to the label 225.

At block 315, the device 100 is configured to determine whether the RF encoding operations initiated at block 310 succeeded. If any of the RF encoding operations failed, the determination at block 315 is negative. For example, if the RF encoding operations at block 310 include reading the TID bank of the RF tag 226, and writing the RF data from the command to the EPC bank of the RF tag 226, if either or both of the read operation and the write operation fail, the determination at block 315 is negative. If each RF encoding operation initiated at block 310 succeeds, the determination at block 315 is affirmative.

Based on the determination at block 315, the device 100 is configured to select an indicator for printing to the label 225, in addition to the print data in the command from block 305. That is, the device 100 is configured to select an indicator based on an outcome of the RF encoding operation(s).

At block 320, following an affirmative determination at block 315, the device 100 is configured to select a positive indicator. Following a negative determination at block 315, the device 100 can be configured to select a negative indicator at block 325. In some examples, block 325 can be omitted, and the device 100 can select between a positive indicator for successful RF encoding operations, and no indicator for failed RF encoding operations. When an error indicator is selected at block 325, in some examples the error indicator can include an error description, such as a string of text, an error code, or the like. The string of text can include a description of the type of error encountered and/or other diagnostic information. In some examples. When the error indicator includes an error code, e.g., functioning as a reference to a description or other diagnostic information, the error code can be inserted into a uniform resource locator (URL), which can be printed, e.g., encoded in a barcode.

At block 330, the device 100 is configured to control the printhead 216 to apply the print data from the command to the label 225, as well as the selected indicator (if any) from block 320 or block 325. Following the performance of block 330, the device 100 can return to block 305, e.g., to receive a further command to print a further label 225.

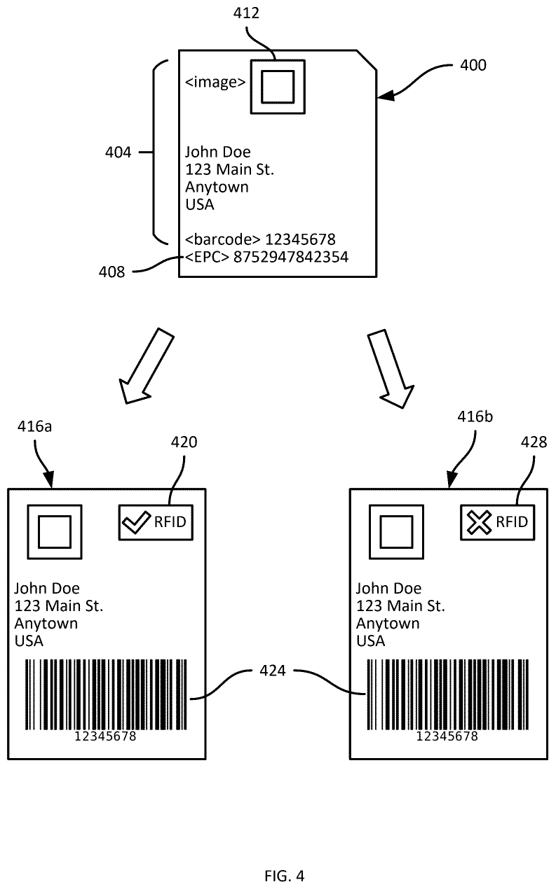

The selection and printing of indicators at blocks 320-330 can be implemented in various ways. For example, turning to FIG. 4, a command 400 is illustrated including print data 404, and RF data 408, e.g., including an EPC. The command 400 can be received at the device 100 in one or more messages, files, or the like, and need not be received in the form illustrated in FIG. 4. In the illustrated example, the print data 404 includes an image such as a logo 412 or the like, a mailing address (e.g., a destination address for a parcel), and a barcode generation command. The print data 404 can include additional information in other examples, such as an origin mailing address or the like. The print data 404 can also include a barcode image in other examples, rather than a command for the device 100 to generate a barcode. As will be apparent to those skilled in the art, the print data 404 can also include formatting information, e.g., defining positions on the label 225 for the various components of the print data 404.

FIG. 4 illustrates a first label 416a, resulting from an affirmative determination at block 315, selection of a positive indicator 420 at block 320, and printing of the label 416a at block 330. The label 416a includes the print data 404 (including a barcode 424 generated based on the barcode command in the print data 404), and the indicator 420 printed in a distinct region from the print data 404, such that the indicator 420 does not overlap (and thus potentially obscure) with the print data 404. The indicator 420 can take any of a wide variety of forms, including the example shown in FIG. 4, including a check mark to indicate a successful RF encoding operation. The indicator 420, in other words, indicates that the label 416a includes a functioning RF tag 226.

FIG. 4 also illustrates a second label 416b, resulting from a negative determination at block 315, selection of a negative indicator 428 at block 325, and printing of the label 416b at block 330. The label 416b also includes the print data 404, and the negative indicator 428 printed in a non-overlapping region of the label 416b from the print data 404. In this example, the negative indicator includes an “X” indicating that RF encoding failed for the label 416b, and that the label 416b therefore does not have a functioning RF tag 226. The region containing the indicator 428 is the same as the region containing the indicator 420, in this example. The device 100 can store the indicators 420 and 428 in the memory 234. The device 100 can be configured to selectively retrieve one of the indicators 420 and 428, based on the outcome of the RF encoding operations, and print the retrieved indicator at a specified or predefined position. In some examples, position at which the indicators 420 and 428 can be dynamically specified based on the output of the RF encoding operations and the print data 404. As an example, the device 100 can determine an area on the label 416a or 416b having a surface area that is sufficient to print the indicator 420 or 428 and that will not include any of the print data 404. The indicators 420 and 428 need not be received with the command 400 in this example, and the computing device that generated the command 400 need not be modified to include additional label formats, store the indicators 420 and 428, or the like.

In some examples, the indicator 420 or 428 can be printed according to a print command that is executed separately from the print command associated with the print data 404 based on the output of the RF encoding operations. As an example, the print command for the indicator 420 or 428 can be executed in parallel with the print command for the print data 404 or can be executed sequentially. In some examples, the print command for the print data 404 can be modified by the device 100 to integrate the indicator 420 or 428 into the print command for the print data based on the output of the RF encoding operations. The indicators 420 and 428 can include other images in other examples, and/or text strings (e.g., the string “RFID” shown in FIG. 4, or other strings indicating the outcome of the RF encoding operation), and/or barcodes encoding an outcome indicator.

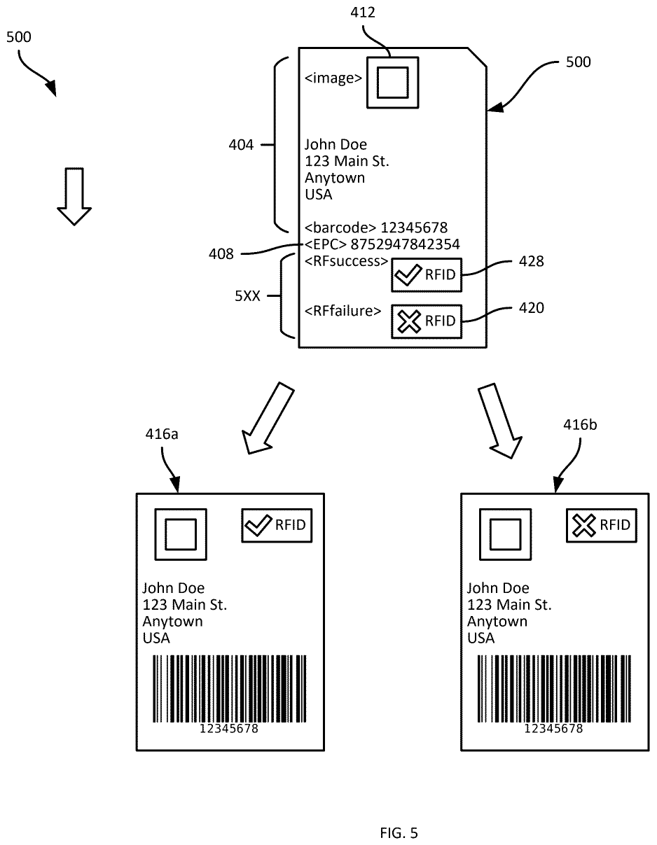

FIG. 5 illustrates another example command 500, including the print data 404 (which also includes the image 412), and the RF data 408. In addition, the command 500 includes the indicators 420 and 428, e.g., along with formatting information defining the region(s) of the labels 416a and 416b that contain the indicators 420 and 428. The command 500 can also include a selection criterion for either or both indicators, e.g., the parameters “RFsuccess” and “RFfailure” to define which of the indicators 420 and 428 are to be used following which RF encoding operation outcomes. In other words, the device 100 can be configured to select the indicators at blocks 320 and 325 directly from the command itself, in some implementations. The implementation of FIG. 5 permits the host computing device that generated the command 500 to control which indicators are used (e.g., to substitute different images for the indicators 420 and/or 428).

Alternatively, with reference to FIG. 5, the command 500 can include the print data 404, the RF data 408, and the indicators 420 and 428. The device 100 can received the command 500 and can be programmed with criteria for dynamically determining which one of the indicators 420 and 428 will be printed based on an output of the RF encoding operations such that the device 100 defines the selection criterion and selects one of the indicators 420 or 428.

As described herein, one indicator (420 or 428) can be specified to indicate success or failure of the RF encoding operations where an absence of the indicator can specify the other of success or failure. In these embodiments, with reference to FIG. 4, the device 100 determine whether or not to print the indicator based on the output of the RF encoding operations (e.g., print the indicator 428 upon failure or do not print an indicator upon success), and with reference to FIG. 5, the command includes one indicator (420 or 428), and the device 100 determines whether or not to print the indicator based on the selection criterion (either specified in the command 500 or specified by the device 100) and the output of the RF encoding operations (e.g., print the indicator 428 upon failure or do not print an indicator upon success).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a media processing device, the method comprising:
receiving a command including first data and second data;
based on the second data, performing an operation on a radiofrequency (RF) tag associated with a label;
selecting an indicator based on an outcome of the operation; and
controlling a printhead to apply the first data and the indicator to the label.

2. The method of claim 1, wherein controlling the printhead includes:
applying the first data to a first region of the label, and the indicator to a second region of the label.

3. The method of claim 1, wherein the operation includes at least one of reading data from the RF tag, and writing the second data to the RF tag.

4. The method of claim 1, wherein selecting the indicator includes:
selecting a first indicator when the operation succeeds.

5. The method of claim 4, wherein selecting the indicator includes:
selecting a second indicator when the operation fails.

6. The method of claim 4, wherein the first indicator includes at least one of:
an image,
a barcode, or
a text string.

7. The method of claim 4, wherein the second indicator includes at least one of:
an image,
an error code, or
an error description.

8. The method of claim 1, further comprising:
in response to the selection, retrieving the indicator from a repository stored at the media processing device.

9. The method of claim 1, wherein the command contains the indicator and a selection criterion; and
wherein selecting the indicator includes determining whether the outcome of the operation meets the selection criterion.

10. A device, comprising:
a housing;
a printhead disposed in the housing, the printhead being configured to print on a media supply;
a radiofrequency (RF) assembly disposed in the housing; and
a controller configured to:
receive a command including first data and second data;
based on the second data, controlling the RF assembly to perform an operation on a RF tag associated with a label of the media supply;
select an indicator based on an outcome of the operation; and
control the printhead to apply the first data and the indicator to the label.

11. The device of claim 10, wherein the controller is configured to control the printhead by:
applying the first data to a first region of the label, and the indicator to a second region of the label.

12. The device of claim 10, wherein the operation includes at least one of reading data from the RF tag, and writing the second data to the RF tag.

13. The device of claim 10, wherein the controller is configured to select the indicator by:
selecting a first indicator when the operation succeeds.

14. The device of claim 13, wherein the controller is configured to select the indicator by:
selecting a second indicator when the operation fails.

15. The device of claim 13, wherein the first indicator includes at least one of:
an image,
a barcode, or
a text string.

16. The device of claim 13, wherein the second indicator includes at least one of:
an image,
an error code, or
an error description.

17. The device of claim 10, wherein the controller is configured to:
in response to the selection, retrieve the indicator from a repository stored at the device.

18. The device of claim 10, wherein the command contains the indicator and a selection criterion; and
wherein the controller is configured to select the indicator by determining whether the outcome of the operation meets the selection criterion.
